(19) United States
(12) Patent Application Publication
(10) Pub. No.: US 2022/0386705 A1
(43) Pub. Date: Dec. 8, 2022

(54) CLEANING TOOL WITH DOUBLE CLEANING HEAD FOR AN AEROSOL-GENERATING DEVICE

(71) Applicant: PHILIP MORRIS PRODUCTS S.A., Neuchatel (CH)

(72) Inventors: Matteo Bologna, Lausanne (CH); Ferdinando Carignani, Napoli (IT)

(21) Appl. No.: 17/760,582

(22) PCT Filed: Sep. 17, 2020
(86) PCT No.: PCT/EP2020/076053

§ 371 Date: Mar. 15, 2022

(30) Foreign Application Priority Data
Sep. 20, 2019 (EP) 19198516.7

(51) Int. Cl. A24F 40/85; B08B 1/00

(52) U.S. Cl. CPC A24F 40/85; B08B 1/005

(57) ABSTRACT

The cleaning device for an aerosol-generating device comprises a cleaning tool having a first cleaning head and a second cleaning head, wherein the first cleaning head and the second cleaning head are arranged back-to-back with each other and wherein the clean-ing heads of the cleaning tool have an identical structural form.

The present invention relates to a cleaning tool for an aerosol-generating device. In particular, the invention relates to a cleaning tool for cleaning at least a heating element of an aerosol-generating device.

Aerosol-generating articles in which an aerosol-forming substrate for generating an inhalable aerosol is heated, rather than combusted, are known in the art. Typically in such heated aerosol-generating articles, an aerosol is generated by the transfer of heat from a heat source to a physically separate aerosol-forming substrate or material. The aerosol-forming substrate may be located within, around or downstream of the heat source. During use, volatile compounds are released from the aerosol-forming substrate by heat transfer from the heat source and entrained in air drawn through the aerosol-generating article. As the released compounds cool, they condense to form an aerosol. Such aerosol-generating articles are typically provided in a container of aerosol-generating articles, much like a cigarette container or pack.

International patent publication WO 2013/102614 discloses an example of an electrically operated aerosol-generating device in which an aerosol-forming substrate of an aerosol-generating article is heated in direct contact with a heating element to form an inhalable aerosol. The heating element is in the form of a blade which is inserted into an aerosol-forming substrate segment of an aerosol-generating article. It is also known to insert heating pins into such aerosol-forming substrate segments, instead of or in addition to a heating blade.

In such a device configuration, heat from the heating element may be conveyed almost instantaneously to at least a portion of the aerosol-forming substrate when the heating element is actuated, and this may facilitate the rapid generation of an aerosol. Furthermore, the overall heating energy required to generate an aerosol may be lower than would be the case in a system where the aerosol-forming substrate does not directly contact a heating element and initial heating of the substrate occurs by convection or radiation. Where a heating element is in direct contact with an aerosol-forming substrate, the initial heating of portions of the substrate that are in contact with the heating element will be effected by conduction.

When an aerosol-forming substrate, such as a tobacco substrate, is heated, volatile compounds are released. Volatile compounds and aerosol evolved by the heat from the heating element may become deposited on the aerosol-generating device and in particular on a surface of the heating element. Particles of the aerosol-forming substrate itself may also become adhered to the heating element, particularly if the heating element is in direct contact with the aerosol-forming substrate. For example, when using the device described in WO 2013/102614, a heating blade warms a tobacco substrate to temperatures between 200 to 350 degree Celsius, releasing volatile compounds, nicotine and glycerol. All of the released volatile compounds form a respiratory aerosol at consuming. However, residues and dust tend to collect inside the cavity in the device after smoking multiple aerosol-generating articles.

It is therefore desirable to periodically clean the heating element and the cavity in which the heating element is located. Such periodical cleaning to remove particles and compounds adhered to and deposited on the heating element or in the cavity of an aerosol-generating device may ensure an optimal functioning of the aerosol generating device. Cleaning of the heating element and maintaining tidy conditions in the cavity chamber allow for an optimal flavour sensation to a user.

A cleaning tool usually comprises a cleaning head that relies on physical contact to remove any debris from the heating elements or the heating cavity. The cleaning head may slowly wear out or degrade upon continued use. As a consequence the cleaning efficiency of the cleaning head may reduce over time.

The present invention aims to solve the afore-mentioned technical problem providing an improved cleaning device, such as, a cleaning device with an extended life use. More specifically, the present invention provides a cleaning device which allows to carry multiple cleaning heads to clean same or different parts of the aerosol-generating device for optimizing or diversifying the cleaning actions.

According to an embodiment of the invention the cleaning device for an aerosol-generating device comprises a cleaning tool. The cleaning tool comprises a first cleaning head and a second cleaning head. The first cleaning head and the second cleaning head are arranged ‘back-to-back’ with each other.

The term ‘back-to-back’ refers to the configuration that the two cleaning heads are provided at either of the two ends of an elongate cleaning tool. In this configuration, the cleaning heads point to opposite directions. The backsides of the cleaning heads contact each other and are fixed to each other.

The cleaning device aggregated with multiple cleaning heads is easier to handle in comparison with a cleaning device having a single cleaning head, since the cleaning head is often very small and may be difficult to manipulate by a user. Moreover, such arrangement may optimize the use of material and resources by regrouping multiple cleaning heads into one device.

The cleaning tool may be an elongate cleaning tool. The cleaning heads may be provided at either end of the elongate cleaning tool. In this way either end of the elongated cleaning tool may be used for cleaning an aerosol-generating device.

The cleaning heads of the cleaning tool may have an identical structural form. By providing an additional, spare cleaning head the life use of the cleaning device may be extended. If one of the cleaning heads has worn out or degraded over time due to repeated use, the other cleaning head may be used for continued use of the cleaning device.

The cleaning heads of the cleaning tool may also have a different structural form. The cleaning tool may be provided with two or more cleaning heads, wherein each cleaning head may be designed for cleaning different parts of the aerosol-generating device. This may additionally increase usability of the cleaning device. Moreover, the aerosol-generating device may have different needs of which parts need to be cleaned. For example, the heating blade and the interior wall of the heating chamber may require different scraping surface, such as one flat surface or one curved surface. The arrangement with different cleaning heads may thus provide the possibility to diversify the cleaning actions.

The cleaning device may be designed such that the first cleaning head and the second cleaning head are detachable from each other. By configuring the cleaning heads detachable from each other, flexibility of use of these cleaning heads may additionally be increased. For instance, the worn-out cleaning head can be independently replaced with a new cleaning head.

One of the cleaning heads may be T-shaped and may comprise an elongate element with a transversal element mounted to one end of the elongate element. The transversal element of such cleaning head may have an outer edge and an inner edge. The outer edge is the edge of the transversal element that faces away from the cleaning tool. The inner edge is opposite to the outer edge and the inner edge is the edge of the transversal element that faces towards the elongate element of the cleaning tool.

At least one of the outer edge or the inner edge of the transversal element may be configured to form a scraping surface. For example the inner edge of the transversal element may be sharpened to increase its cleaning capabilities.

As used herein a “scraping surface” is a surface of the cleaning device that is configured for scraping, caressing, brushing, swabbing or otherwise exercising a cleaning action to a surface of the aerosol-generating device.

The cleaning device of the present invention may be used to clean cavities of aerosol-generating devices described. Such aerosol-generating devices may comprise an extractor. An extractor may be a detachable part that forms at least part of a heating cavity. Such an extractor may have a tubular shape forming a generally closed bottom surface at one end of the extractor. The bottom surface of the extractor may have an elongate eyelet. The eyelet may be in the form of a slit on the bottom surface of the extractor. In use of the aerosol-generating device, a heating element such as a heating blade may extend through the slit and pierce into the aerosol-forming substrate of the aerosol-generating article when the aerosol-generating article is inserted into the extractor.

An extractor may facilitate removal of an aerosol-generating article from the aerosol-generating device. Upon removal of the extractor from the aerosol-generating device the aerosol-generating article, which is inserted into the extractor, is simultaneously removed.

The T-shaped cleaning head may be configured to be used for cleaning such an extractor of an aerosol-generating device. The transversal element of the T-shaped cleaning head may be inserted into the eyelet of the extractor. The T-shaped cleaning head may then be rotated and slightly pulled to press against the bottom surface of the extractor. In this way the inner edge of the cleaning tool that is formed as a scraping surface is rotated over and frictionally engages with the bottom surface of the extractor. By such movement any debris or other tobacco leftovers may be loosened and subsequently removed from the bottom surface of the extractor.

The elongate element of the T-shaped cleaning head may comprise a safety element to prevent inadvertent use of the cleaning tool. The safety element may stop a cleaning head from accidently reaching certain parts of the aerosol-generating device. The safety element may therefore prevent a cleaning head from being erroneously used to clean certain parts of the aerosol-generating device and may particularly help to avoid damages on the heating element, such as the heating blade of the aerosol-generating device. The safety element may be an area of increased diameter or width depending on the cross-sectional shape of the area on safety element. The safety element preferably has a diameter or width that is larger than the diameter of the cavity to be cleaned. In this way the cleaning head can only be inserted so far into the cavity until the safety element contacts the peripheral wall defining the opening of the cavity. The safety element prevents the cleaning head from being inserted too far into the cavity of the extractor. It may therefore avoid any damage the cleaning head may cause on the heating element of the aerosol-generating device. The safety element may have a rectangular, circular or tubular cross section.

The safety element may have a size which may allow it to be easily held between the fingers. The safety element may form a handle for operating the cleaning device when one of the cleaning heads is used.

The T-shaped cleaning head may be made from metallic material or plastic material. The T-shaped cleaning head may be made from hard plastic material.

One of the cleaning heads of the cleaning device may be provided in the form of a flexible spring. This cleaning head is referred to herein as spring cleaning head. The spring may be formed from a wire that is wound to form a helical coil. The coil may have dimensions that correspond to the dimensions of the heating chamber or the extractor of the aerosol-generating device to be cleaned. The outer diameter of the spring may be smaller than the inner diameter of the extractor or of the aerosol-generating device. The longitudinal length of the spring in a tension-free state may be equal to or longer than the depth of the extractor. In this way the cleaning tool may be inserted into the extractor and the front end of the spring may be used to clean the bottom surface of the extractor of the aerosol-generating device.

The front end of the spring may be formed such that its end defines a scraping surface. For example the last winding of the end of the spring may be cut to form a scraping surface. In this way the front end of the spring may facilitate the removal of the tobacco leftovers. The front end may also be shaped in any other way that is useful to efficiently scrap the inner surfaces of the heating chamber.

The side surface of the spring may also define a scraping surface. The side surface of the spring may be used for cleaning the inner side walls of the heating chamber or the extractor of the aerosol-generating device. For this cleaning action, the spring may be alternately moved up-and-down into the heater cap. At the same time the spring may be bent such as to add extra-pressure on the inner side wall of the extractor during the cleaning motion.

The spring cleaning head may be used to clean the extractor, when the extractor is detached from the aerosol-generating device. In this detached state the heating element is released from the extractor and there is no risk that the heating element gets damaged during the cleaning process.

However, the spring cleaning head may also be designed such that even if it is inserted into the heating chamber when the extractor is still attached to the aerosol-generating device, the risk of damaging the heating element is reduced. In this regard, the inner diameter of the spring may be larger than the outer dimensions of the heating element of the aerosol-generating device. When the spring cleaning head is inserted into the heating chamber, the heating element is accommodated in the inner volume defined by the spring.

The spring can be a traction spring. A traction spring can be formed as a contiguous spiral that may have a generally smooth and continuous peripheral outer surface. This may be useful when sliding the cleaning tool into the extractor. Such smooth sliding is also possible when the traction spring is getting bent during the cleaning process. In such the traction spring may extend the spirals, which still allows a smooth sliding of the spring into the element to clean.

The spring can also be designed as a compression spring. In the extended state, a compression spring may have a length that is larger than the depth of the extractor to be cleaned. If not in use, the compression spring may be compressed such that the cleaning tool may fit into a housing of the cleaning tool, as described further below.

The spring may also be a mixture of a traction spring and a compression spring such that both of the above mentioned advantages may be obtained at the same time. Such spring may have portions that primarily allow for smooth sliding of the cleaning head and may in addition comprise portions that are compressible such that the cleaning tool may be stored in a housing having a smaller size compared to the size of the spring in its extended configuration.

The spring may be made from any suitable material. The spring may be made from a metallic material.

The cleaning device of the present invention may comprise a cleaning tool with a first cleaning head being provided in the form of a spring cleaning head and a second cleaning head being provided as a T-shaped cleaning head, wherein each of these cleaning heads are configured as described above.

The cleaning device of the present invention may comprise a cleaning tool comprising a third cleaning head. The third cleaning head may have an elongate, substantially cylindrical cleaning body

The cleaning body of the third cleaning tool may define a recess for receiving a heating element of an aerosol-generating device. The recess may extend along the full length of the cleaning head. The recess may extend along a part of the full length of the cleaning head. The cleaning head may be provided with at least one protrusion inwardly extending or projecting into the recess of the cleaning head.

The cleaning body may be insertable into a heating chamber or extractor of an aerosol-generating device, which contains one or more heating elements, such as a heating blade or a heating pin. The cleaning body may have a recess for receiving such a heating element of the aerosol-generating device. Within the cleaning body of the third cleaning head there may be at least one protrusion which extends or projects into the recess.

Advantageously, by providing the third cleaning head with at least one protrusion which extends into the recess, the third cleaning head may be used to clean the heating element by moving the third cleaning head relative to the heating element such that the at least one protrusion engages with the heating element, when the heating element is disposed within the recess of the third cleaning head. The recess and the at least one protrusion can therefore form a cleaning portion of the first cleaning tool, which can be used to clean a heating element.

Preferably, the at least one protrusion is elastically deformable. This can improve the cleaning effect of the at least one protrusion. For example, this may help to increase the contact time between the at least one protrusion and the heating element during cleaning. This may also help to reduce the risk of the at least one protrusion damaging the heating element during cleaning.

The at least one protrusion is therefore preferably formed of a flexible material. The flexible material should preferably be such that when the third cleaning head is moved within the cavity in the device, the at least one protrusion can bend while abutting the heating element, without damaging it. This bending action whilst in contact with the heating element can result in a wiping action of the heating element, and thereby remove debris from the heating element.

Preferably, the at least one protrusion comprises or is formed of one or more thermoplastic elastomers (TPE), such as one or more of Arnitel, Hytrel, Dryflex, Mediprene, Kraton, Pibiflex, Sofprene, and Laprene.

The at least one protrusion disposed within the recess may be formed of the same material as the cleaning body of the third cleaning head. Preferably, the at least one protrusion disposed within the recess is formed of a different material than that which forms the cleaning body of the third cleaning head. For example, the cleaning body of the third cleaning head may be formed of a mouldable plastic and the at least one protrusion disposed within the recess may be formed of a flexible material, such as one or more thermoplastic elastomers. Such an arrangement may help to reduce the risk of the at least one protrusion damaging the heating element during cleaning and meanwhile also provide a reinforcement to the cleaning head.

The at least one protrusion disposed within the recess may be secured to the cleaning body by way of an adhesive. The at least one protrusion may be mechanically secured to the cleaning body.

The cleaning body may have any suitable shape which can enable it to be inserted into a cavity of an aerosol-generating device. Preferably, the cleaning body is substantially cylindrical. That is, preferably the cleaning body has a substantially circular cross-sectional shape. This can be advantageous for a number of reasons. For example, since aerosol-generating articles are generally cylindrical, a cavity for an aerosol-generating device is often also generally cylindrical. By providing the third cleaning head with a cylindrical cleaning body, the third cleaning head can be easily located within the cavity of such aerosol-generating devices. Furthermore, the cylindrical shape of the cleaning body can help to ensure that the third cleaning head, and in particular the third cleaning head's at least one protrusion, is appropriately aligned with a heating element within the cavity of the device. This can help to improve the cleaning effect of the third cleaning head. In addition, the cylindrical shape of the cleaning body can allow for the third cleaning head to be stored and transported in a container for aerosol-generating articles. This is because the tool can occupy the space that might otherwise have been occupied by an aerosol-generating article within the container.

Preferably, the cleaning body of the third cleaning head has a total length of between approximately 40 millimetres and approximately 60 millimetres. Preferably, the cleaning body of the third cleaning head has a total length of approximately 50 millimetres.

Preferably, the cleaning body of the third cleaning head has an external diameter of between approximately 6 millimetres and approximately 11 millimetres. Preferably, the cleaning body of the third cleaning head has an external diameter of approximately 10 millimetres.

Preferably, the at least one protrusion is substantially planar. Preferably, the major dimension of the substantially planar protrusion extends along at least a portion of the length of the cleaning body. The major dimension of the substantially planar protrusion extends along a line which is parallel to the longitudinal axis of the cleaning body. A substantially planar protrusion may advantageously provide an improved cleaning effect over other cleaning objects such as brushes, because it can have an increased contact area with the heating element.

Preferably, the at least one protrusion disposed within the recess extends along at least 20 percent of the length of the cleaning body. More preferably, the at least one protrusion disposed within the recess extends along at least 30 percent of the length of the cleaning body. Preferably, the at least one protrusion disposed within the recess extends along less than 70 percent of the length of the cleaning body. By arranging for the protrusion to extend along such a length, the protrusion can be used to clean the majority or all of the length of the heating element.

Preferably, the at least one protrusion extends from a peripheral region of the cleaning body towards a radial centre of the cleaning body.

A single protrusion may be provided in the recess. Alternatively, the at least one protrusion may consist of a plurality of protrusions, each of which inwardly extends or projects into the recess. This may help to increase the cleaning efficiency of the third cleaning head.

Preferably, the protrusions are uniformly disposed around the recess. This may help to provide a more even cleaning of a heating element disposed within the recess.

The recess may extend through the entire length of the cleaning body of the third cleaning head. Alternatively, the recess may extend from the end face along a part of the elongate body.

Where the recess only extends along a part of the length of the elongate body of the tool, preferably the length of the recess is equal to at least 10 percent of the length of the elongate body. More preferably, the length of the recess is equal to at least 25 percent of the length of the elongate body. Even more preferably, the length of the recess is equal to at least 40 percent of the length of the elongate body.

With the exception of the opening at the end face of the cleaning body, the recess may be fully enclosed by the cleaning body. This means that any debris which becomes deposited in the recess during cleaning may not easily escape said recess after cleaning. This can advantageously reduce the likelihood of such debris coming into contact with the consumer or another article, after the tool has been moved away from the aerosol-generating device.

The cleaning body may include one or more openings along a side wall of the cleaning body, and the recess may extend from the end face of the cleaning body to said one or more side openings. Such side openings may help a consumer to remove debris from the recess between cleaning, if desired. For example, a consumer could blow through the recess or one of the side openings to dispel any debris from the recess after use of the first cleaning tool. Use of such one or more side openings may also allow for the third cleaning head to be manufactured using less material.

Advantageously, by providing a cleaning portion of the third cleaning head within an internal region of the third cleaning head, dirt or debris removed by the third cleaning head during cleaning is less likely to come into contact with other objects, such as a consumer's fingers, after the third cleaning head has been removed from the cavity of the aerosol-generating device. The third cleaning head may therefore be handled easily and user-friendly.

Alternatively or in addition the cleaning body of the third cleaning head may comprises a scraping surface at the end face of the cleaning body. The scraping surface can allow for mechanical cleaning of surfaces within the cavity of the aerosol-generating device, and in particular, surfaces disposed at the base of the cavity. Preferably the scraping surface is configured to clean the inner surface of the cavity of the aerosol-generating device, and in particular, one or more surfaces disposed at the base of the cavity.

The scraping surface of the third cleaning head may be a flat surface. When the inner surface of the cavity of the aerosol-generating device is also flat, the scraping surface and the inner surface of cavity may fully contact each other. This may ensure an optimal cleaning efficiency. Alternatively, the scraping surface of the third cleaning head may have a curved surface at the end face of the third cleaning head. A curved scraping surface may achieve better contact to a curved inner surface of the cavity of the aerosol-generating device. Thus, a curved scraping surface may achieve an optimal cleaning efficiency when cleaning curved inner surfaces. The scraping surface of the third cleaning head may be a sharp tip formed by the convergence of two edges of the third cleaning head. For example, the scraping surface may be defined by a second set of protrusions at the end face of the cleaning body. Each protrusion in the second set of protrusions may have a curved edge defining the scraping surface. Such a curved surface may be shaped to conform to a curved surface present at the base of a cavity of the aerosol-generating device.

Each protrusion in the second set of protrusions may be in the form of a tooth comprising at least two ridges extending around a recessed portion. Preferably, each tooth comprises three connected ridges, which partially surround a recessed portion. Preferably, the middle ridge has a convex leading edge, and the ridges either side of the middle ridge each have a concave leading edge.

Preferably, the second protrusions are uniformly disposed around the recess.

Preferably, the third cleaning head comprises no more than six protrusions forming the scraping surface, more preferably no more than four protrusions forming the scraping surface. In some preferred embodiments, the plurality of protrusions forming the scraping surface consists of between 2 and 4 protrusions. In some particularly preferred embodiments, the plurality of protrusions forming the scraping surface consists of 3 protrusions.

Preferably, the scraping surface is disposed around a peripheral region of the end face of the cleaning body.

Preferably, the scraping surface is formed of a rigid material. Preferably, the scraping surface is formed of the same material as the material forming the cleaning body. Preferably, the scraping surface is formed of a plastic, such as a polyimide.

The cleaning body of the third cleaning tool may be provided with a central passing hole that may be dimensioned such as to accommodate the spring of the spring cleaning head or the spring of a combined tool including a spring cleaning head and a T-shaped cleaning head. The central passing hole extends from the end face of the cleaning body of the third cleaning tool that is opposite to the third cleaning head along the central longitudinal axis of the third cleaning tool and has a length such as to accommodate the complete spring of the spring cleaning head.

One of the cleaning heads may comprise an elongate element. The elongate element may be an elongate tapered element. Such elongate tapered element may have the shape of a cylindrical-shaped stick with a frustoconical end. Such cleaning head may be used to clean the bottom of the heating chamber or the cavity of the extractor into which the aerosol-generating articles are inserted, such as, the side surface or corner areas of the extractor. The elongate element may be extendable. The elongate element may be telescopically extendable. In this way, in the retracted state, the cleaning head with the elongate element may be completely stored within a housing of the cleaning device. Upon use, the elongate element may be brought into the extended state, in which it is long enough to allow the user to reach all surfaces of the aerosol-generating device for cleaning.

The elongate element may have a generally cylindrical shape comprising a longitudinal slit at one end. The longitudinal slit may be configured for mounting a cleaning swab thereon. The cleaning swab may be of generally rectangular shape and may have dimensions that correspond to the dimensions of the longitudinal slit. In particular, the length of the longitudinal slit may correspond to the length of the cleaning swab. In order to mount the cleaning swab in the longitudinal slit, one edge of the cleaning swab may be inserted into the longitudinal slit. Subsequently the cleaning swab may be rolled around the cylindrical portion of the second cleaning tool. In this way the cleaning swab forms a cylindrical cleaning head that may be used for cleaning the inner side of a heating chamber of an aerosol-generating device or the cavity of an extractor of an aerosol-generating device.

The elongate element of the cleaning head may have a generally cylindrical shape and may be hollow. The inside surface, the outside surface or both of the inside and outside surface of the elongate element may be covered with flexible abrasive elements. The flexible abrasive elements may have the form of hooks. The flexible abrasive element may be made from plastic material. The flexible abrasive elements may be provided in a form similar to a velcro strip. The elongate hollow element may be inserted into the extractor to clean of debris or residuals sticking to the inner wall of the extractor. The cleaning head may also be used to clean the extractor when the extractor is attached to the aerosol-generating device. In this case the heating element may be accommodated in the inner volume of the hollow elongate element. The abrasive elements provided at the inside of the hollow elongate element may scrape of debris and residuals sticking to the surface of the heating element.

The cleaning device may comprise a housing. The housing of the cleaning device may be formed by plural parts. Advantageously the housing is formed by a first cap and a second cap.

Each of the caps may engage with the cleaning tool and may accommodate at least a part of one of the cleaning heads of the cleaning device. When one cap is removed to allow access to the corresponding cleaning head, the other cap may remain attached to the cleaning tool and may form a handle for the cleaning head to be used.

The connection between the two caps and the cleaning tool can be established by any connection means known to the person skilled in the art. In particular the connection can be a screw connection, a friction-fit connection or a form-fit connection. The connection between the caps and the cleaning tool may be such that relative rotation between the caps and the cleaning tool is prevented. The connection means between the caps and the cleaning tool may comprise longitudinal grooves provided at the caps and the cleaning tool. The longitudinal grooves engage with each other and thereby efficiently prevent relative rotation between these parts.

In an embodiment the connection between the caps and the cleaning tool can be a snap-fit connection. The first cap and the second cap may have connection means that engage with corresponding connection means of the cleaning tool. At least one of the first cap and the second cap may be formed from any material having a suitable module of elasticity. At least one of the first cap and second cap may be formed from plastic material such as elastic polymeric material. The caps may be dis-engaged from the cleaning tool by temporarily generating increased friction between one of the caps and the cleaning tool. The cap which temporarily has lower friction with the cleaning tool may then be removed. Increase of friction can be obtained by squeezing, pushing or pressing a flexible portion of the first cap or the second cap. This allows easy use and reliable handling of the cleaning device.

The cleaning tool may be sized and shaped to conform to the size and shape of an aerosol-generating article. In particular, the cleaning tool may be provided with a cross-sectional shape equivalent to that of an aerosol-generating article. This may allow for the cleaning tool to be included within a bundle of aerosol-generating articles, when a container of aerosol-generating articles is being manufactured. This may allow for one or more cleaning tools according to the invention to be supplied to a consumer within a container of aerosol-generating articles.

Features described in relation to one embodiment may equally be applied to other embodiments of the invention.

The invention will be further described, by way of example only, with reference to the accompanying drawings in which:

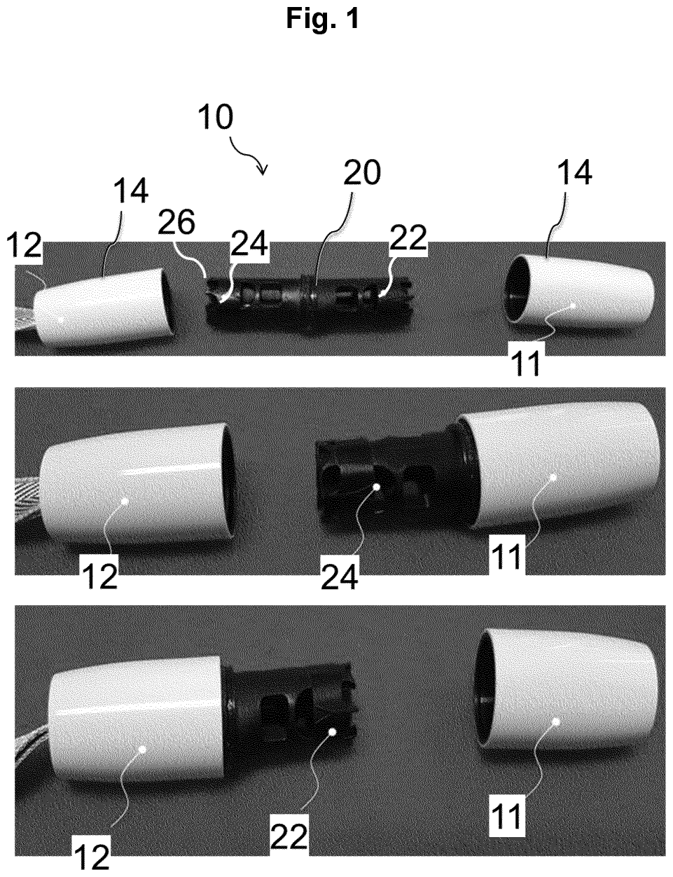

FIG. 1 shows a cleaning device with two identical cleaning heads;

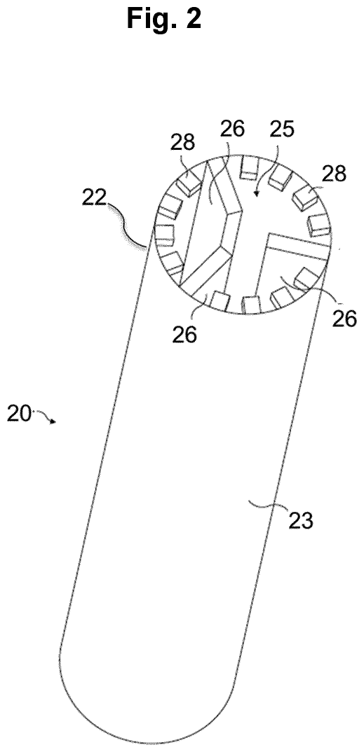

FIG. 2 shows a detailed view of a cleaning head of FIG. 1;

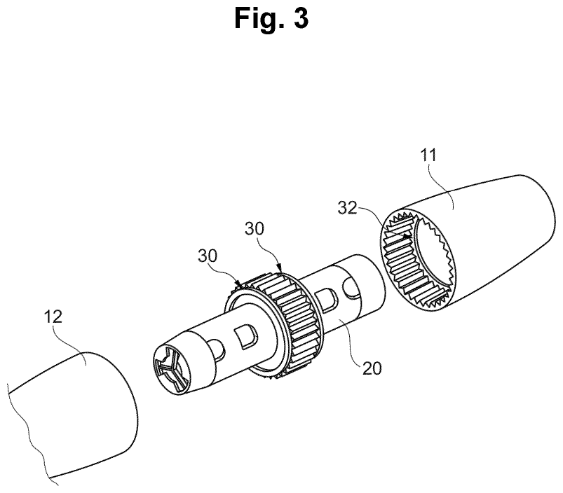

FIG. 3 shows connection elements with longitudinal grooves

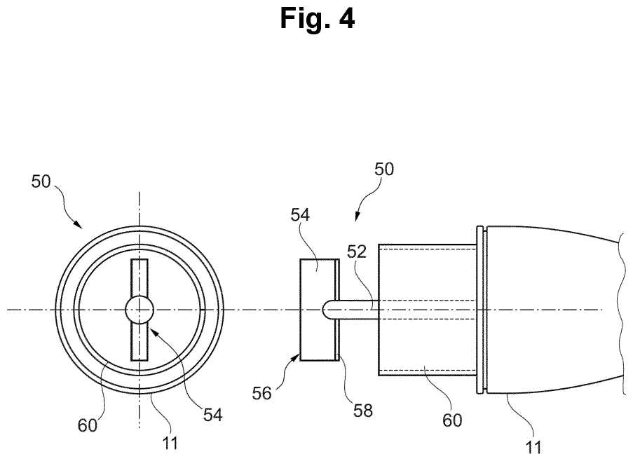

FIG. 4 shows a T-shaped cleaning head;

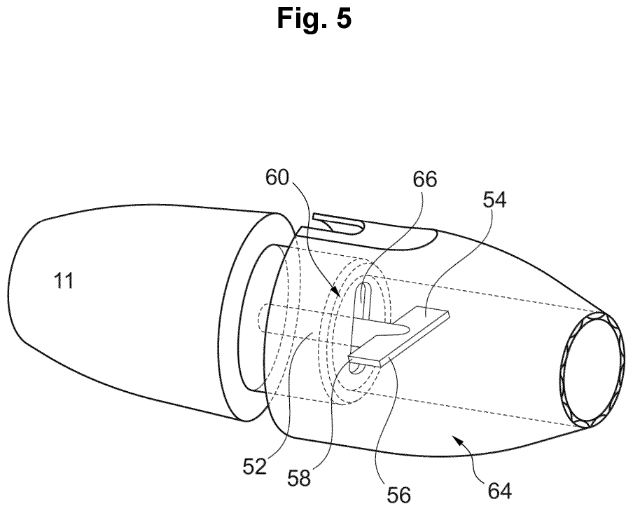

FIG. 5 shows a T-shaped cleaning head during use for cleaning a extractor;

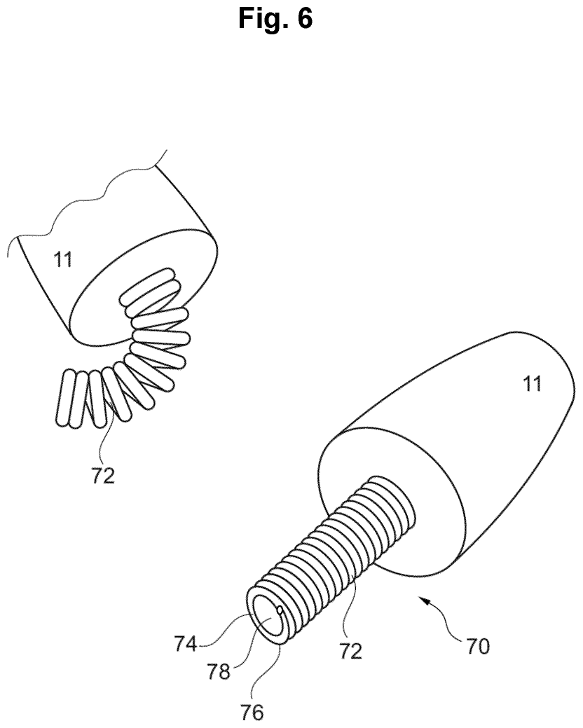

FIG. 6 shows a cleaning head comprising a spring;

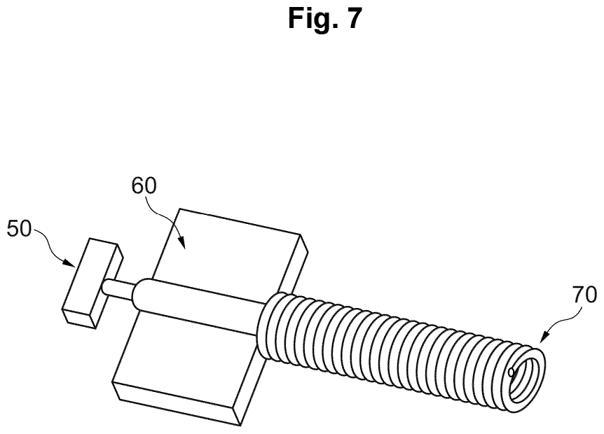

FIG. 7 shows a cleaning tool comprising a T-shaped cleaning head and a cleaning head comprising a spring;

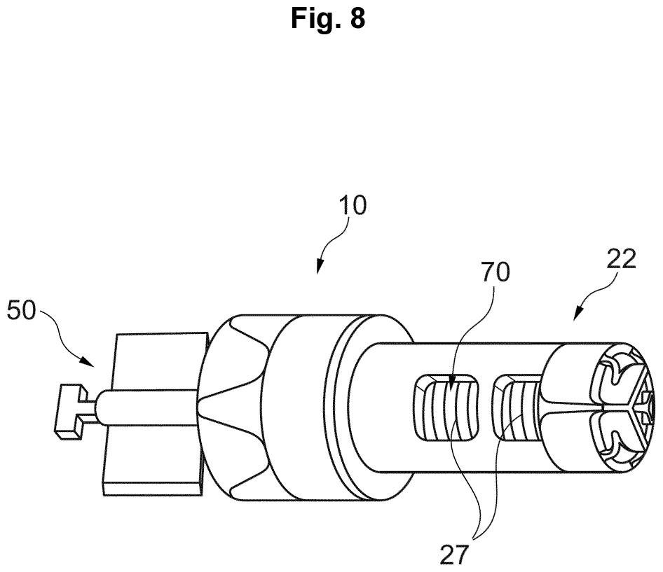

FIG. 8 shows a cleaning tool comprising three cleaning heads;

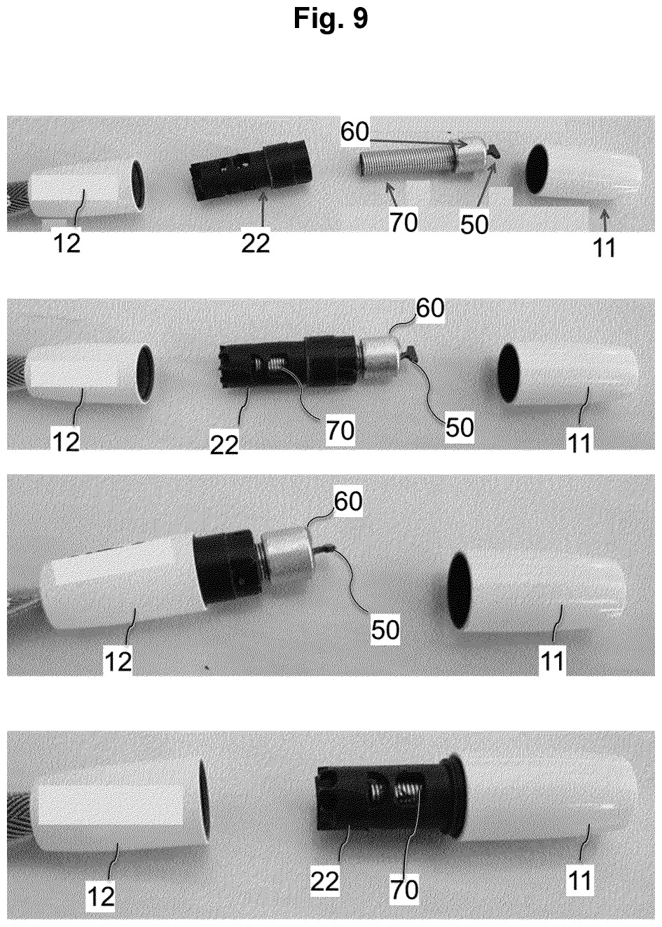

FIG. 9 shows a cleaning tool comprising three cleaning heads in various assembly states;

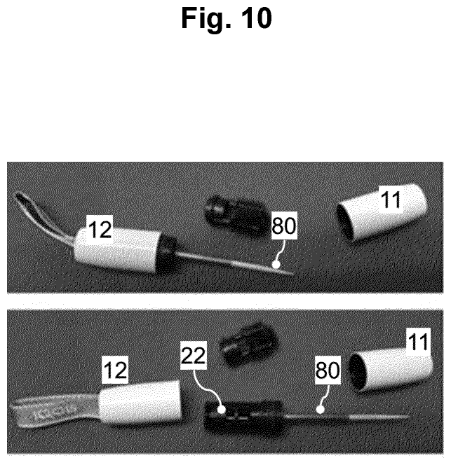

FIG. 10 shows a cleaning head comprising an elongate tapered element;

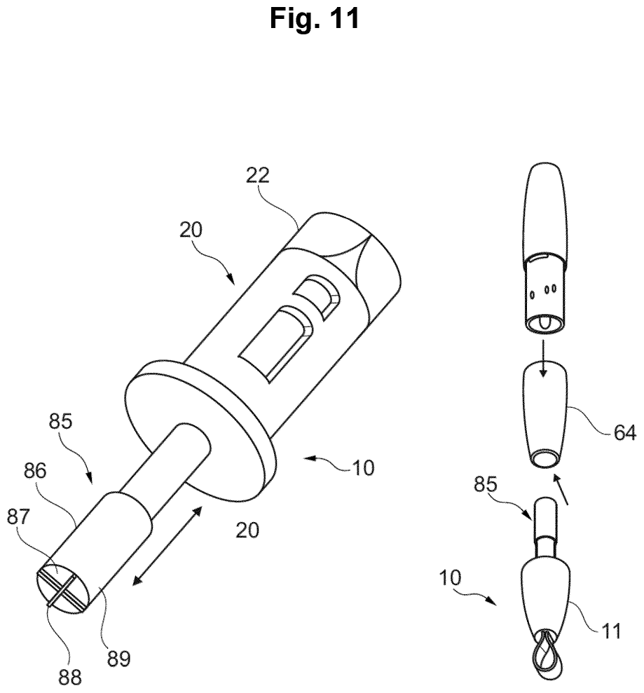

FIG. 11 shows a cleaning head comprising an elongate extendible element;

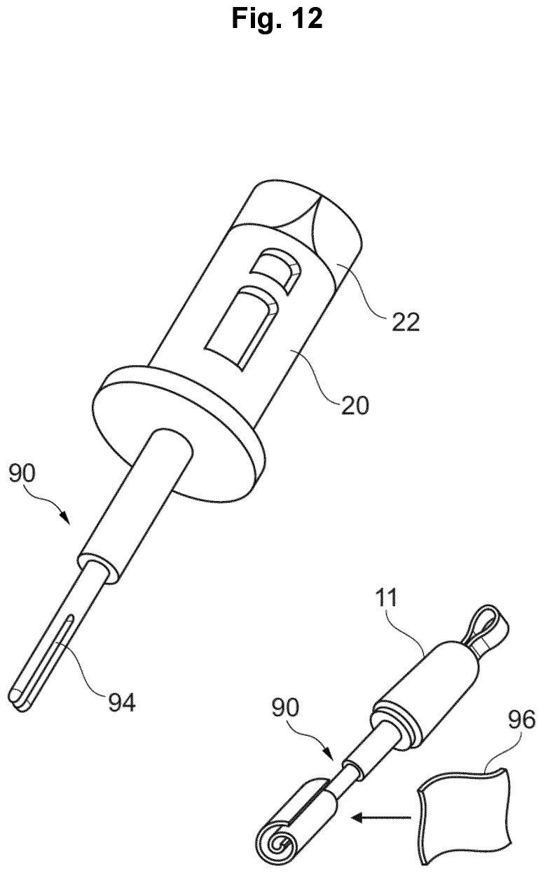

FIG. 12 shows a cleaning head comprising an elongate element and a swap;

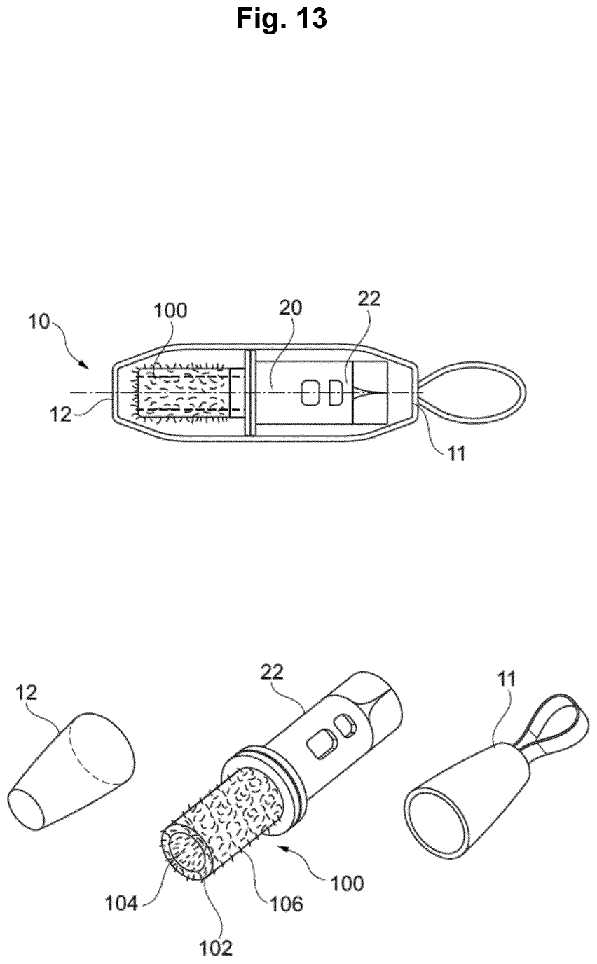

FIG. 13 shows a cleaning head comprising an elongate hollow element;

FIG. 1 shows an embodiment of a cleaning device 10 in accordance with the present invention. The cleaning device 10 comprises a housing 14 consisting of a first cap 11 and a second cap 12. The cleaning device 10 further comprises an elongate cleaning tool 20 having a first cleaning head 22 and a second cleaning head 24. The first cleaning head 22 and the second cleaning head 24 are provided at either end of the elongate cleaning tool 20 and are arranged on the cleaning tool 20 back-to-back with each other.

In the uppermost view of FIG. 1 the first cap 11, the second cap 12 and the cleaning tool 20 are disassembled from each other. In each of the two other views one cap 11, 12 is attached to the cleaning tool 20. The attached cap 11, 12 forms a handle for using the uncovered cleaning head 22, 24.

The two cleaning heads 22, 24 provided at either end of the cleaning tool 20 have an identical design. Each cleaning head 22, 24 is made from polymeric material and defines a recess for receiving a heating element of an aerosol-generating device. Each cleaning head 22, 24 is provided with three protrusions 26 inwardly extending or projecting into a recess of the respective cleaning head 22, 24. The construction of the cleaning heads 22, 24 is described in more detail below with reference to FIG. 2.

FIG. 2 shows a perspective schematic view of a cleaning head 22 of the cleaning tool 20 depicted in FIG. 1. The cleaning tool 20 comprises an elongate cleaning body 23 having a generally cylindrical shape. The cleaning head 22 defines a recess 25 for receiving a heating element of an aerosol-generating device.

The cleaning head 22 comprises a first set of protrusions 26. Each of these protrusions 26 extends into a central region of the recess 25. In the embodiment of FIG. 2, three such protrusions 26 are provided, with said protrusions 26 being uniformly spaced around the recess 25.

When the cleaning tool of FIG. 2 is in use, a heating element can be inserted into the recess 25 such that at least a portion of the length of the heating element extends along at least a portion of the length of the recess 25. The cleaning tool 20 can then be moved relative to the heating element, for example by rotating the cleaning tool 20 relative to the heating element. Such rotational movement can cause debris being removed from the surface of the heating element.

The cleaning head 22 comprises also a second set of protrusions 28. These protrusions 28 are disposed around the peripheral region of the cleaning head 22, with each of said protrusions 28 extending towards the central region of the cleaning head 22. In the embodiment of FIG. 2, twelve such protrusions 28 are provided, with said protrusions 28 being uniformly spaced around the recess 25.

The cross section size of the protrusions 28 is smaller than that of the protrusions 26. The second protrusions 28 are preferably formed of a rigid material, such as a polyimide. The first protrusions 26 are preferably formed of a flexible material, such as a thermoplastic elastomer. In the embodiment of FIG. 2, the second protrusions 28 are formed integrally with the elongate cleaning body 22.

The second protrusions 28 can together form a scraping surface, which can be used to provide a different cleaning function from that of the first protrusions 26. In particular, the second protrusions 28 can be used to clean the base of a cavity which contains a heating element of an aerosol-generating device, such as the heating chamber of an aerosol-generating device. The cleaning function of the second protrusions 28 can be initiated by movement of the cleaning tool 20 relative to the heating element in the heating chamber of an aerosol-generating device. Such movement may be a rotational movement. Alternatively, such movement may be a combination of a rotational and linear movement.

The connection between the two caps 11, 12 and the cleaning tool 20 is a snap-fit connection that is configured to prevent relative rotation between these parts. As depicted in FIG. 3 a central portion of the cleaning tool 20 comprises longitudinal groves 30. The longitudinal grooves 30 extend around the complete circumference of the central portion of the cleaning tool 20. The rim of each of the caps 11, 12 is provided with corresponding groove structures 32. When a cap 11, 12 is attached to the cleaning tool 20, the longitudinal grooves 30 of the cap 11, 12 and the longitudinal grooves 32 of the cleaning tool 20 engage with each other and thereby efficiently prevent relative rotation between these parts.

In FIG. 4 an alternative configuration of a cleaning head 50 for the cleaning tool 20 is depicted. This cleaning head 50 is formed as T-shaped. The T-shaped cleaning head 50 comprises an elongate element 52 and a transversal element 54 at one end of the elongate element 52. The transversal element 54 has an outer edge 56 and an inner edge 58. The inner edge 58 of the transversal element 54 is configured to form a scraping surface.

The cleaning head 50 further comprises a safety element 60 that prevents inadvertent use of the cleaning tool 20. The safety element 60 is a cylindrical element having an increased diameter that is larger than the width of the transversal element 54. In addition, the diameter of the safety element 60 is larger than the diameter of the cavity of the extractor 64. When the extractor 64 is still assembled on the aerosol-generating device and the T-shaped cleaning head 50 is erroneously inserted into the cavity of the extractor 64 by the user, the safety element 60 may prevent the T-shaped cleaning head 50 from being inserted too deep into the heating chamber. In this way potential damages on the heating element, such as, the heating blade, may be eliminated.

In addition, during a proper cleaning operating, when the extractor 64 is detached and removed from the aerosol-generating device and a user intends to use the T-shaped cleaning head 50 to clean the inner bottom surface of the cavity of the extractor 64 as shown in FIG. 5, the safety element 60 may ensure proper use of this cleaning head 50. In this case, the T-shaped cleaning head 50 may only extend through the eyelet 66 and get into the cavity of the extractor 64 to the necessary extent for its scraping surface on the inner edge 58 of the transversal bar 54 to contact the inner bottom surface of the extractor 64.

As depicted in FIG. 5 the T-shaped cleaning head 50 is configured to be used for cleaning a bottom internal surface of a extractor 64 of an aerosol-generating device. The transversal element 54 of the T-shaped cleaning head 50 is to be inserted into an eyelet 66 of such extractor 64. The T-shaped cleaning head 50 may then be rotated and slightly be pressed with its inner scraping edge 58 against the bottom internal surface of the extractor 64. By rotational movement of the cleaning head 50 any debris or other residuals may be loosened and subsequently removed from the bottom surface of the extractor 64.

Alternatively or in addition, the outer edge 56 of the transversal element 54 of the T-shaped cleaning head 50 may also be used as a scraping surface. For this purpose the T-shaped cleaning head 50 may be inserted into the extractor 64 through its other end and may be inserted all the way through the extractor 64 until the outer edge 56 of the transversal element 54 of the T-shaped cleaning head 50 engages with the bottom surface of the extractor 64. By rotating over and frictional engagement with the bottom surface of the extractor 64, any debris or other tobacco leftovers may be loosened and subsequently removed from the external bottom surface of the extractor 64.

In FIG. 6 a further configuration of a cleaning head 70 of the cleaning tool 20 of the present invention is depicted. This cleaning head 70 comprises a spring 72. The spring 72 is a traction spring and is formed from a wire 74 that is wound to form a helical coil. The dimensions of the coil are designed such that the coil may be inserted into the cavity of an extractor or heating chamber of an aerosol-generating device.

The front end 76 of the spring 72 is formed to define a scraping surface. The last winding of the spring is cut such that this end can be used to scrap the bottom surface of the extractor upon rotational movement of the cleaning head 70. Upon insertion and extraction of this cleaning head 70 the outer peripheral side surface of the coil may have frictional contact with the inner longitudinal side wall of the cavity of the extractor or heating chamber of an aerosol-generating device upon use for cleaning. The increased contact surface with the longitudinal side wall of the cavity instead of scraping only the bottom side of the extractor or heating chamber of an aerosol-generating device may optimize the cleaning efficiency.

The spring 72 has an inner diameter that is larger than the width dimensions of a heating element of the aerosol-generating device. Thus, if the cleaning head 70 is inserted into the heating chamber, when the extractor is still attached to the aerosol-generating device, the heating element may be accommodated within the inner volume 78 of the spring 72. Thus, the risk of damaging the heating element is reduced.

In the embodiment depicted in FIG. 7, the cleaning device 10 comprises a cleaning tool 20 that has at one end a T-shaped cleaning head 50 of FIG. 4 and at the other end a spring cleaning head 70 of FIG. 6. Such cleaning tool 20 provides two different cleaning heads 50, 70 in a compact form.

The safety element 60 in FIG. 7 has a rectangular cross section. Such safety element 60 avoids the risk that the T-shaped cleaning head 50 gets in contact with the heating element of the aerosol-generating device when the T-shaped cleaning head 50 is erroneously inserted into the cavity of the extractor while the extractor is still assembled on the aerosol-generating device. In addition, the flat rectangular side walls of the safety element 60 makes the cleaning device easy to be held between the fingers and therefore the safety element may advantageously form a handle for operating the cleaning device when one of the cleaning heads 50, 70 is used.

In the embodiment depicted in FIG. 8, the cleaning device 10 comprises even three different cleaning heads 22, 50, 70. The cleaning tool 20 depicted in FIG. 7 is arranged within a cleaning head 22 as depicted in FIG. 2. The cleaning head 22 is provided with a passing hole 27 having a diameter and a length to accommodate the spring 72.

FIG. 9 shows all elements of the cleaning device 10 of FIG. 8 in various states of assembly. In the upper view of FIG. 9 all elements, the caps 11, 12, the cleaning tool 20 with a first cleaning head 50 on one side and a second cleaning head 70 on the other side, and an additional element provided as a third cleaning head 22 of the cleaning device 10 are depicted in a disassembled state. In the second view of FIG. 9 the cleaning tool 20 is accommodated within the additional third cleaning head 22. In the third view of FIG. 9, the T-shaped cleaning head 50 is exposed to be removed for use when the cap 11 is detached from the cleaning tool 20. In the fourth view of FIG. 9, the cap 11 is attached and forms a handle for using the third cleaning head 22.

FIG. 10 shows a further embodiment of a cleaning device 10 of the present invention. The cleaning tool 20 comprises two different cleaning heads 22, 80 at its two opposite ends. One cleaning head 22 corresponds to the cleaning head of FIG. 2. The other cleaning head 80 is an elongate tapered element in the form of a tapered stick. Again each of the caps 11, 12 may be attached to either end of the cleaning tool 20 and may form a handle for manoeuvring the opposite cleaning head 80, 22.

FIG. 11 shows a further embodiment of a cleaning device 10 of the present invention. The cleaning tool 20 comprises two different cleaning heads 22, 85 at its two opposite ends. One cleaning head 22 corresponds to the cleaning head of FIG. 2. The other cleaning head 85 comprises an extendible element 86 having a generally cylindrical shape. The end face 87 as well as the peripheral side surfaces 89 of this cleaning head 85 may be used for the cleaning action. At the end face 87 of the extendible element 86 a cross shaped element 88 forms a scraping surface for cleaning the bottom surface of an extractor 64 or the heating chamber of an aerosol-generating device. In addition, the peripheral side surfaces 89 of this cleaning head 85 may be used for cleaning the inner side of a heating chamber of an aerosol-generating device or the cavity of the extractor 64 of the aerosol-generating device. The peripheral side surface 89 may be provided with a suitable abrasive surface to improve the cleaning performance. As can be seen from the right view of FIG. 11 the cleaning device 10 may be used for cleaning the extractor 64 or the heating chamber of an aerosol-generating device or both. As depicted in FIG. 11 the extractor 64 may be removed from the aerosol-generating device before cleaning. Again each of the caps 11, 12 may be attached to either end of the cleaning tool 20 and may form a handle for manoeuvring the opposite cleaning head 85, 22.

FIG. 12 shows a further cleaning head 90 to be used in a cleaning device 10 according to the present invention. This cleaning head 90 comprises an extendible element having a generally cylindrical shape. An end portion of the cylindrical element comprises a longitudinal slit 94. A cleaning swab 96 is to be mounted in the longitudinal slit 94. The cleaning swap 96 is of generally rectangular shape and has a length that corresponds to the length of the longitudinal slit 94. In order to mount the cleaning swap 96 in the longitudinal slit 94, one edge of the cleaning swab 96 is inserted into the slit 94. Subsequently the cleaning swab 96 is rolled around the cylindrical portion of this cleaning head 90. In this way the rolled up cleaning swap 96 may be used for cleaning the inner side of a heating chamber of an aerosol-generating device or the cavity of the extractor of the aerosol-generating device.

FIG. 13 shows a further embodiment of the cleaning device 10 of the present invention. The cleaning tool 20 comprises two different cleaning heads 22, 100 at its two opposite ends. One cleaning head 22 corresponds to the cleaning head of FIG. 2. The other cleaning head 100 comprises an elongate cylindrical element in the form of a hollow tube.

The inside surface 104 and the outside surface 102 of the elongate element is covered with flexible abrasive scraping elements in the form of hooks 106. The abrasive scraping elements are made from plastic material.

The dimensions of the tubular element are such that the cleaning head 100 can be inserted into the cavity of the extractor of an aerosol generating device. By moving the cleaning head 100 in and out of the extractor, debris or residuals sticking to the inner wall of the cavity of the extractor may be removed. The abrasive scraping elements provided at the inside surface 104 of the hollow elongate element may be used to scrape off and gather debris and residuals sticking to the surface of the heating element. Again each of the caps 11, 12 may be attached to either end of the cleaning tool 20 and may form a handle for manoeuvring the uncovered cleaning head 100, 22.

1.-14. (canceled)

15. A cleaning device for an aerosol-generating device, comprising a cleaning tool, wherein the cleaning tool comprises a first cleaning head and a second cleaning head, wherein the first cleaning head and the second cleaning head are arranged back-to-back with each other, and wherein one cleaning head comprises an elongate element with a transversal element mounted to one end of the elongate element.

16. The cleaning device according to claim 15, wherein the cleaning tool is elongate and the cleaning heads are provided at either end of the elongate cleaning tool.

17. The cleaning device according to claim 15, wherein the first cleaning head and the second cleaning head are detachable from each other.

18. The cleaning device according to claim 15, wherein the transversal element comprises an outer edge and an inner edge and wherein at least one of the outer edge and the inner edge of the transversal element is configured to form a scraping surface.

19. The cleaning device according to claim 15, wherein the elongate element comprises a safety element to prevent inadvertent use of the cleaning tool.

20. The cleaning device according to claim 15, wherein one cleaning head is a spring.

21. The cleaning device according to claim 20, wherein the spring is a traction spring, or a compression spring or a combination of both traction and compression springs.

22. The cleaning device according to claim 20, wherein the spring is a metallic spiral having an end configured as a scraping surface.

23. The cleaning device according to claim 20, wherein the cleaning tool further comprises a third cleaning head, wherein the third cleaning head has an elongate, substantially cylindrical body with a central passing hole, the central passing hole being dimensioned to accommodate the spring cleaning head.

24. The cleaning device according to claim 15, wherein one cleaning head is an elongate tapered stick and the stick is preferably telescopically extendable.

25. The cleaning device according to claim 15, wherein one cleaning head is a hollow cylindrical element, which is covered on its inside surface, on its outside surface or on both the inside and the outside surface with flexible abrasive elements.

26. The cleaning device according to claim 15, further comprising a housing comprising two caps, wherein each cap is configured to house one cleaning head.

27. The cleaning device according to claim 26, wherein the cap that houses one cleaning head forms a handle for operating the tool when the other cleaning head is used.
